(19) United States
(12) Patent Application Publication
(10) Pub. No.: US 2011/0305492 A1
(43) Pub. Date: Dec. 15, 2011

(54) FIXING DEVICE AND IMAGE FORMING APPARATUS

(76) Inventors: Kenji Tamaki, Tokorozawa-shi (JP); Masashi Sugano, Tokyo (JP); Akinori Kimata, Toyokawa-shi (JP); Katsunori Takahashi, Tokyo (JP); Akifumi Isobe, Tokyo (JP); Satoshi Shimao, Tokyo (JP)

(21) Appl. No.: 13/157,774

(22) Filed: Jun. 10, 2011

(30) Foreign Application Priority Data
Jun. 15, 2010 (JP) JP2010-135949

(51) Int. Cl. G03G 15/20

(52) U.S. Cl. 399/323

(57) ABSTRACT

A fixing device includes: a fixing section which passes a sheet through a fixing nip portion formed by a pair of fixing members and thereby fixes a toner image on the sheet by heating; a blowing section which separates the sheet from the fixing members by blowing separation wind from a sheet discharge side of the fixing nip portion to the fixing members; an opening setting section which is provided with an opening region in which an opening width in a sheet width direction is adjustable, and adjusts a blowing range in the sheet width direction of the separation wind blown through the opening range from the blowing section to the fixing members; a temperature detection sensor for detecting temperature of the fixing members; and a control section which controls the opening width of the opening setting section based on the temperature detected of the fixing members.

### CROSS REFERENCE TO RELATED APPLICATION

The present application is based on Japanese patent application No. 2010-135949 filed with Japanese Patent Office on Jun. 15, 2010, and the entire content of which is hereby incorporated by reference.

### TECHNICAL FIELD

The present invention relates to a fixing device and an image forming apparatus using the same.

### BACKGROUND

Conventionally, electrophotographic image forming apparatuses have been known as printers and copiers. In such image forming apparatuses, a process is carried out in such a manner that when a toner image is formed on a sheet, such a toner image is transferred onto a sheet, and thereafter the sheet is passed between a pair of fixing members of the fixing device (through the fixing nip portion) to fix the toner image onto the sheet. In this case, the fixing temperature of the fixing device, specifically, the temperature of each fixing member affects the fixing performance of such a toner image. Therefore, to enhance image quality, it is critical to control the fixing temperature.

Further, in an image forming apparatus of this type, due to carrying out fixing by heating and pressurization, there occurs, in some cases, a disadvantage in which a sheet having been passed through the fixing nip portion remains wound around a fixing member and thereby is not separated from the fixing member. Therefor, an image forming apparatus provided with an air separation function to separate a sheet from a fixing member is disclosed in which separation wind is blown to the fixing member from the sheet discharge side of the fixing nip portion (for example, refer to Unexamined Japanese patent application Publication (hereinafter referred to as JP-A) No. 2005-258035).

Incidentally, for example, JP-A No. 10-198219 discloses an image forming apparatus provided with a cooling mechanism in which the direction of air flowing in an air pathway above the fixing device is changed to uniformly cool a fixing member. Further, for example, JP-A No. 5-107983 discloses an image forming apparatus provided with a cooling mechanism in which a large number of fans are arranged on both sides of the axis direction of a fixing member and also the blowing amount of each fan is independently adjustable.

### BRIEF DESCRIPTION OF THE INVENTION

### Problems to be Solved by the Invention

Incidentally, in the method disclosed in JP-A No. 2005-258035, the blowing range (the blowing width) of the sheet width direction of separation wind blown to a fixing member has the same width, regardless of the sheet size. Therefore, in cases in which the sheer size is smaller than the blowing width of the separation wind, the temperature of the fixing member in the non-sheet passing region of a sheet is decreased, whereby the fixing member may be cooled beyond necessity. In this case, there occurs a disadvantage in which the energization amount for the heater to heat the fixing member is increased. Further, even in the case where the sheet size and the blowing width of separation wind are the same, when the heating region of the fixing member of the sheet width direction is larger than a sheet passing region, the temperature of the fixing member in the non-sheet passing region is increased, resulting in the possibility of degradation of the fixing member.

Further, in JP-A No. 10-198219, merely from the viewpoint of cooling a fixing member, air is just blown with no consideration of either air separation or fixing temperature management. Namely, in the method disclosed in JP-A No. 10-198219, to realize an air separation function, in addition to a cooling mechanism, an air separation mechanism needs to be added, resulting in the possibility of size increase and complexity of the apparatus. Still further, in the method disclosed in JP-A No. 5-107983, an air separation function may be considered to be realized using a cooling mechanism, but due to a plurality of fans provided, a disadvantage, in which the apparatus is complicated and the size thereof is increased, may occur.

In view of these circumstances, the present invention was completed. An object thereof is to effectively inhibit the decrease or increase of the temperature of a fixing member in the non-sheet passing region resulting from separation wind to separate a sheet from the fixing member.

### SUMMARY OF THE INVENTION

To achieve at least one of the above mentioned objects, a fixing device reflecting one aspect of the present invention comprises: a fixing section which passes a sheet through a fixing nip portion formed by press-contacting a pair of fixing members with each other and thereby fixes a toner image on the sheet by heating, the toner image having been transferred onto the sheet; a blowing section which separates the sheet from the fixing members by blowing separation wind from a sheet discharge side of the fixing nip portion to the fixing members; an opening setting section which is provided with an opening region in which an opening width in a sheet width direction is adjustable, and adjusts a blowing range in the sheet width direction of the separation wind blown through the opening range from the blowing section to the fixing members; a temperature detection sensor for detecting temperature of the fixing members; and a control section which controls the opening width of the opening setting section based on the temperature detected of the fixing members.

### BRIEF DESCRIPTION OF THE DRAWINGS

FIG. 1 is a schematic illustration view of the constitution of an image forming apparatus 1;

FIG. 2 is a schematic sectional view of the constitution of a fixing device 50;

FIG. 3 is an illustration view describing the constitution of a heater 60;

FIG. 4 is a schematic view simply showing a duct 59 and peripheral members thereof;

FIG. 5 is an exploded perspective view schematically showing the constitution of an opening setting section 60;

FIGS. 6a and 6b are illustration views showing an operation state of the opening setting section 60;

FIGS. 7a and 7b are illustration views showing an operation state of the opening setting section 60;

FIGS. 8a and 8b are illustration views showing an operation state of the opening setting section 60;

FIG. 9 is a block diagram schematically showing the control system of the image forming apparatus 1;

FIG. 10 is a flowchart showing the control procedure of the fixing device 50 by focusing on the control of the blowing width of separation wind; and

FIGS. 11a and 11b are schematic illustration views of the constitution of an opening setting section 60 according to a second embodiment.

### PREFERRED EMBODIMENTS OF THE INVENTION

### First Embodiment

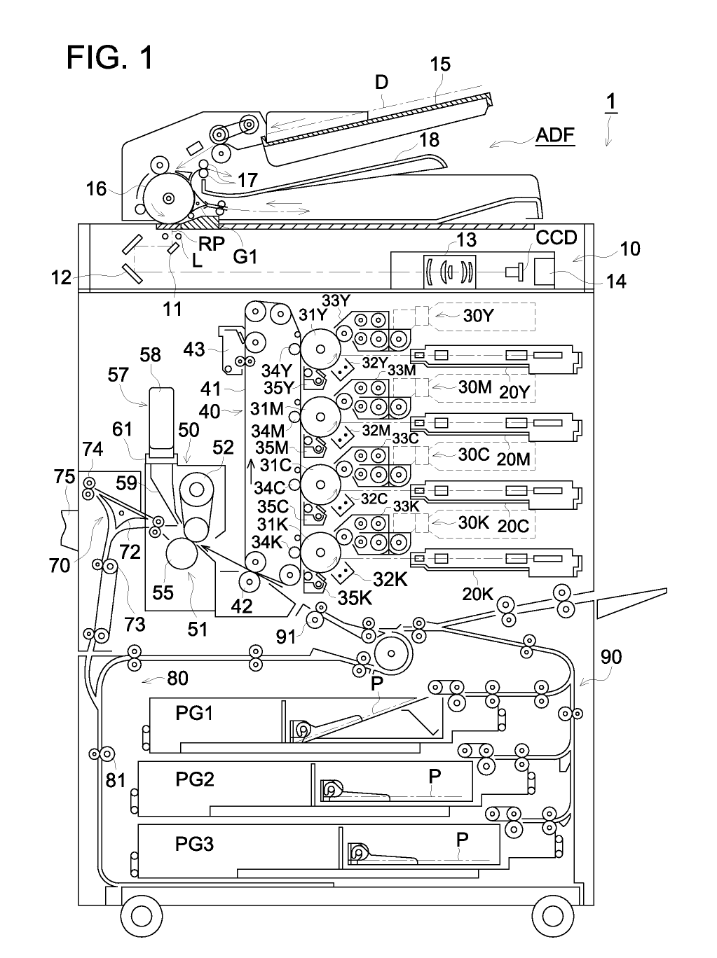

FIG. 1 is a schematic illustration view of the constitution of an image forming apparatus 1 according to the present embodiment. The image forming apparatus 1 is an electrophotographic image forming apparatus such as, for example, a copier, being, namely, a tandem-type color image forming apparatus in which a plurality of photoreceptors are arranged in the vertical direction with respect to an intermediate transfer belt to form a full-color image. Incidentally, in the present specification, when the directions of a sheet P and each member constituting the image forming apparatus 1 are defined, the conveyance direction of the sheet P is designated as the basis. Then, a direction parallel to the conveyance direction of the sheet P is referred to as the “sheet conveyance direction FD” and a direction at right angles to the conveyance direction FD of the sheet P is referred to as the “sheet width direction CD.”

This image forming apparatus 1 is mainly constituted of a document reading section 10, exposure sections 20Y, 20M, 20C, and 20K, image forming sections 30Y, 30M, 30C, and 30K, an intermediate transfer section 40, a fixing device 50, a sheet discharge reversing section 70, a sheet re-feed section 80, and a sheet feed section 90. These are incorporated in one housing.

The document reading section 10 is provided with an automatic document feeder ADF on top thereof. Original documents D having been placed in the document placement table 15 of the automatic document feeder ADF are separated sheet by sheet and sent out to the document conveyance path to be conveyed by the conveyance drum 16. A first conveyance guide G1 and the document discharge roller 17 discharge an original document D having been conveyed by the conveyance drum 16 to the document discharge tray 18.

The document reading section 10 reads, at the original image reading position RP, an image of an original document D while conveyed by the conveyance drum 16. Specifically, at the original image reading position RP, the image of the original document D is exposed with a lamp L. Reflection light via exposure is introduced by a first mirror unit 11, a second mirror unit 12, and a lens unit 13 to be focused on the light receiving surface of an imaging element CCD. The imaging element CCD photoelectrically converts the incident light to output a specific image signal. The thus-output image signal is subjected to A/D conversion to be produced as input image data.

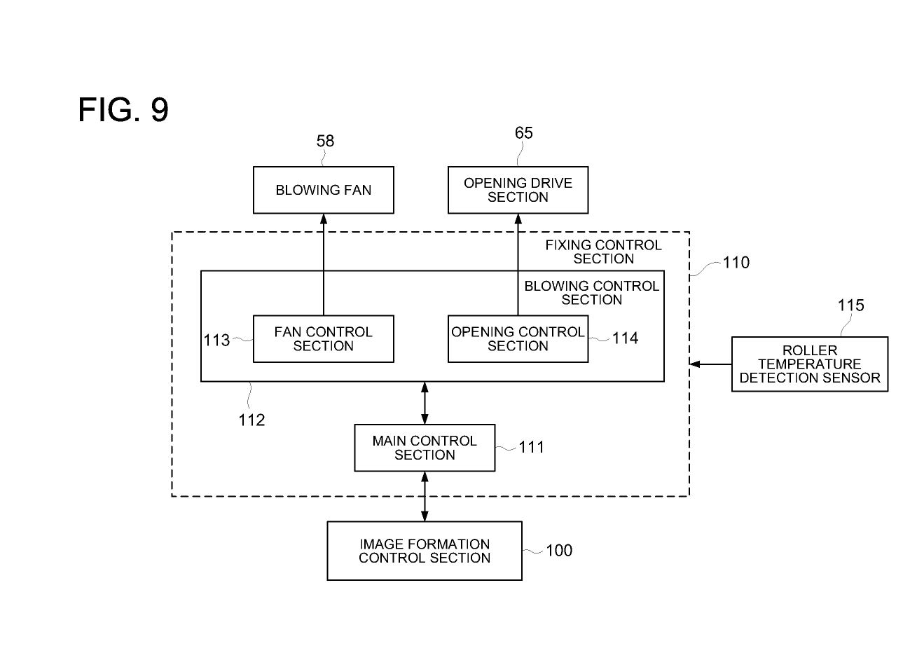

The image reading control section 14 applies shading correction, dither processing, and processing such as compression to the input image data, and thereby data obtained via these processings section 100 (refer to FIG. 9). Herein, the output image data may be not only data output from the document reading section 10 but also those having been received from a personal computer connected to the image forming apparatus 1 or from another image forming apparatus.

The exposure sections 20Y-20K each incorporate a laser light source, a polygon mirror, and a plurality offenses, not shown, to produce laser beams. On the basis of the output image data, the exposure sections 20Y-20K each scan and expose the surfaces of photoreceptors 31Y, 31M, 31C, and 31K being constituent elements of the image forming sections 30Y-30K, using laser beams in response to output information output from the image formation control section 100. Via laser beam scanning exposure, latent images are formed on the photoreceptors 31Y-31K.

The image forming section 30Y is constituted of a photoreceptor 31Y, and a main charging section 32Y, a developing section 33Y, a primary transfer roller 34Y, and a cleaning section 35Y arranged in the periphery of the photoreceptor. The other image forming sections 31M, 31C, and 31K also have the same constitution, and in the periphery of photoreceptors 31M, 31C, and 31K each, main charging sections 32M, 32C, and 32K, developing sections 33M, 33C, and 33K, primary transfer rollers 34M, 34C, and 34K, and cleaning sections 35M, 35C, and 35K are arranged.

The surfaces of the photoreceptors 31Y-31K are uniformly charged by the main charging sections 32Y-32K, respectively. The developing sections 33Y-33K visualize latent images on the photoreceptors 31Y-31K by toner development, respectively. Thereby, on each of the photoreceptors 31Y-31K, a toner image is formed.

The primary transfer rollers 34Y-34K each successively transfer toner images having been formed on the photoreceptors 31Y-31K to predetermined positions on the intermediate transfer belt 41. The cleaning sections 35Y-35K each eliminate the residual toners on the surfaces of the photoreceptors 31Y-31K in which the transfer of the toner images has been terminated.

A secondary transfer roller 42 of the intermediate transfer section 40 transfers a toner image having been transferred on the intermediate transfer belt 41 to a sheet P. Sheets P to be used for transfer are fed from any of the trays PG1, PG2, and PG3 constituting the sheet feed section 90 to be sent to the secondary transfer roller 42 with appropriate timing via the sheet feed roller 91. The belt cleaning section 43 cleans the surface of the intermediate transfer belt 41 in which the transfer of the toner image to the sheet P has been terminated. The thus-cleaned intermediate transfer belt 41 is used for the following image transfer.

Herein, each of the above elements, that is, including the exposure sections 20Y-20K, the image forming sections 30Y-30K, and the intermediate transfer section 40, constitutes an image forming unit. Namely, the image forming unit transfers a toner image on a sheet P through a series of the following processes: (1) the photoreceptors 31Y-31K are charged; (2) electrostatic latent images are formed on the photoreceptor drums 31Y-31K using the exposure sections 20Y-20K; (3) toners are allowed to adhere to the thus-formed electrostatic latent images; (4) the toner images on the photoreceptor drums 31Y-31K are primarily transferred on the intermediate transfer belt 41; and (5) a toner image on the intermediate transfer belt 41 is secondarily transferred on a sheet P.

A sheet P having such a transferred toner image, that is, an unfixed toner image on the fixing-intended side is sent to the fixing device 50. The fixing device 50 fixes the toner image onto the fixing-intended side of the sheet P by pressure heating of the sheet P (a fixing unit). Incidentally, the fixing device 50 will be detailed later.

The sheet discharge reversing section 70 conveys a sheet P having been subjected to fixing by the fixing device 50 for discharging on the sheet discharge tray 75. When a sheet P is discharged via front/rear reversing, the sheet discharge guide 72 temporarily introduces the sheet P downward. The sheet discharge reversing roller 73 nips the end portion of the sheet P and thereafter reversely conveys the sheet P. Then, the sheet discharge guide 72 introduces the sheet P to the sheet discharge roller 74 to discharge the sheet P on the sheet discharge tray 75.

Further, when an image is also formed on the rear surface of a sheet P, the sheet discharge guide 72 conveys a sheet P, in which a toner image on the front surface of the sheet P has been fixed, to the sheet re-feed section 80 located below. The sheet re-feed reversing roller 81 nips the end portion of the sheet P, followed by backward sending for sheet P reversing and then sending to the sheet re-feed conveyance path 82. Thereby, via the sheet re-feed conveyance path 82, the sheet P is fed for rear surface image formation.

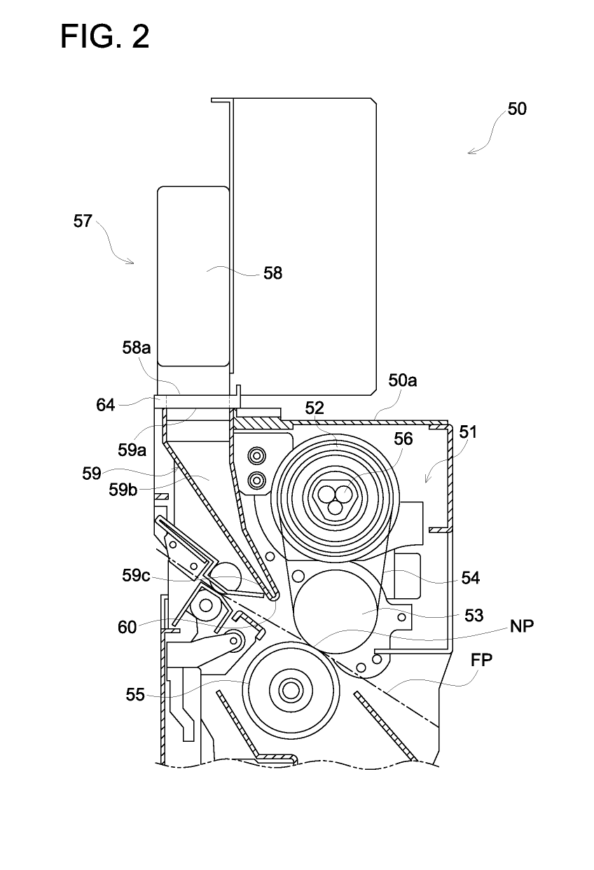

FIG. 2 is a schematic sectional view of the constitution of the fixing device 50. The fixing device 50 is constituted of a fixing section 51 and a blowing section 57.

The fixing section 51 is mainly constituted of a heating roller 52, a fixing upper roller 53, an endless fixing belt 54, and a fixing lower roller 55. The heating roller 52 and the fixing upper roller 53 are arranged with a predetermined distance. Between these rollers 52 and 53, the fixing belt 54 is stretched. The fixing lower roller 55 is arranged in the state of being in pressure contact with the fixing belt 54 in the region where the fixing belt 54 and the fixing upper roller 53 are in contact with each other. And, in the pressure contact portion between the fixing belt 54 and the fixing lower roller 55, a fixing nip portion NP is formed. Herein, for sheet P passing in the fixing nip portion NP, the fixing belt 54 is arranged above the sheet surface and the fixing lower roller 55 is arranged below the sheet surface.

The heating roller 52 is constituted by laminating a coat layer (for example, a fluorine resin) on the surface of a cylindrical pipe of steel or aluminum to prevent wear with the fixing belt 54. Power is transmitted to the heating roller 52 from a drive member (for example, a motor), not shown, for rotational drive. In response to the rotation of the heating roller 52, the fixing belt 54 is rotated. The heating roller 52 rotates the fixing belt 54 in synchronization with the passing rate of a sheet P.

In the interior of the heating roller 52, a heater 56 for heating the fixing belt 54, namely, being a heating source to heat-fix a toner image on a sheet P is incorporated. As the heater 56, for example, a halogen lamp is employable. By radiation heat from this heater 56, the heating roller 52 is warmed, and then the heat possessed by this heating roller 52 is transmitted to the fixing belt 54.

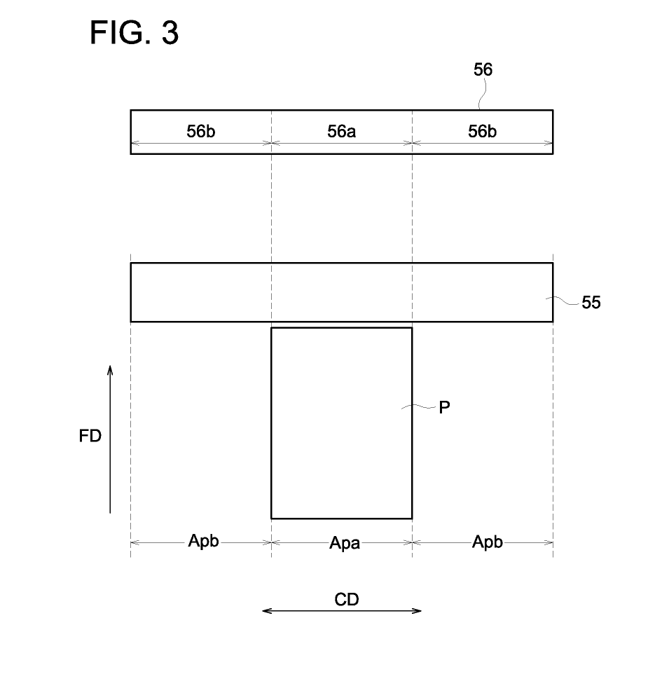

Herein, as shown in FIG. 3, the heater 56 incorporates 3 halogen lamps 56a and 56b, which are arranged nearly linearly in the sheet width direction CD. Herein, of the 3 halogen lamps 56a and 56b, one halogen lamp 56a is centrally arranged in the sheet width direction CD (hereinafter referred to as the “center lamp”), and the remaining halogen lamps 56b are arranged each on one side of the center lamp 56a (hereinafter referred to as the “outside lamps”).

The center lamp 56a is a lamp to heat a region corresponding to the sheet passing region Apa of a sheet P of a standard sheet size such as, for example, A4 size frequently used (hereinafter referred to as the “center heating region”) in the entire region of the heater 56 in the sheet width direction CD. In contrast, each of the outside lamps 56b is a lamp to heat the non-sheet passing region Apb of a sheet P of such a standard sheet size in the entire region of the heater 56 in the sheet width direction CD, that is, to heat a region corresponding to the outside region Apb of the sheet passing region Apa of a sheet P of the standard size (hereinafter referred to as the “outside heating region”). In the present specification, A4 size will be exemplified as the standard sheet size for the following description.

In the heater 56, when a sheet P of A4 size or smaller is fixed, only the center lamp 56a is lit. When a sheet P of a size larger than A4 size is fixed, in addition to the center lamp 56a, the paired outside lamps 56b are lit. The heating state (temperature and region) of the heater 56, that is, the energization state and the energization amount with respect to each of the lamps 56a and 56b are controlled by a fixing control section 110 to be described later.

Referring again to FIG. 2, the fixing upper roller 53 is constituted by laminating an elastic layer such as silicone rubber or sponge on a cylindrical surface of steel or aluminum. In the present embodiment, the fixing upper roller 53 is constituted so as not to be directly heated by the heat of the heater 56.

The fixing belt 54 is an endless belt, having flexibility, constituted by laminating a heat-resistant layer, an elastic layer, and a coat layer. In the present embodiment, the heating roller 52 is directly heated by the heat of the heater 56 and then the heat of the heating roller 52 is transmitted to the fixing belt 54, whereby the fixing belt 54 is heated to the fixing temperature.

The fixing lower roller 55 is constituted by laminating an elastic layer such as silicone rubber and a releasing layer made of a fluorine resin on the surface of a cylindrical pipe of steel or aluminum. Incidentally, the fixing lower roller 55 incorporates a heater (not shown) similarly to the heating roller 52 and has a constitution in which heat for heat fixing can be provided supplementarily.

A sheet P is conveyed so that the fixing-intended surface thereof faces the fixing belt 54 and then passed through the fixing nip portion NP in the course of conveyance of the sheet P. Thereby, via the action of pressure applied by the fixing belt 54 (the fixing upper roller 53) and the fixing lower roller 55 and heat possessed by the fixing belt 54, a toner image is fixed onto the fixing-intended surface of the sheet P. The sheet P having been subjected to toner image fixing is discharged by the sheet discharge roller 74.

The blowing section 57 is constituted of a blowing fan 58, a duct 59, and a heat insulating member 64. The blowing fan 58 and the duct 59 are connected together via the heat insulating member 64.

The blowing section 57 is arranged on the downstream side of the fixing section 51 in the conveyance path FP of a sheet P so that the tip portion (the blowing opening 59c to be described later) of the duct 59 approaches the sheet discharge side of the sheet P in the fixing nip portion NP. In this blowing section 57, air (separation wind) having been blown from the blowing fan 58 is passed through the interior of the duct 59 and then discharged from the blowing opening 59c, whereby by the separation wind blown from the blowing opening 59c, the sheet P is separated from the fixing belt 54 (air separation).

The blowing fan 58 is arranged on the outer wall surface (the upper wall surface 50a in the present embodiment) of the housing of the fixing device 50 accommodating the fixing section 51 and the duct 59. Specifically, the blowing fan 58 is attached to the opening portion placed on the upper wall surface 50a of the housing via a heat insulating member 64. The blowing section 57 of the present embodiment is constituted in such a manner that 3 blowing fans 58 arranged in such a configuration are aligned in the sheet width direction CD.

The individual blowing fan 58 is a blowing member to generate separation wind by taking in air using a rotating fan and at the same time, by blowing out the air having been taken in, being, for example, a multi-vane fan provided with a large number of rotatable forward-facing vanes. The blowing fan 58 takes in external air from the air intake opening (not shown) of the main body side into the main body interior and then blows this air having taken in from the air blowing opening 58c. The number of rotations of the blowing fan 58 of the present embodiment is controlled, whereby it is possible to blow separation wind, to stop blowing separation wind, and to adjust the wind velocity (the wind amount) of separation wind.

Incidentally, the shape and constitution of the blowing fan 58 are not limited to the above ones. If a fan satisfies the function to blow air, any shape and constitution are employable. Further, the blowing fan 58 may blow air outside the machine, instead of air inside the image forming apparatus 1, and may blow a gas other than air alternatively. Further, instead of the blowing fan 58, a blowing member such as a compressor is employable.

The duct 59 is one having a rectangular cross-sectional shape made of metal such as aluminum, being arranged in the vicinity of the heating roller 52 (the heater 56). The duct 59, if functionally considered, is constituted of a blow-in opening 59a connected to each blowing fan 58, a ventilation guide section 59b to introduce separation wind from each blow-in opening 59a, and a single blow-out opening 59c to blow separation wind. Separation wind having been blown into the each blow-in opening 59a is introduced by the ventilation guide section 59b to be discharged from the blow-out opening 59c.

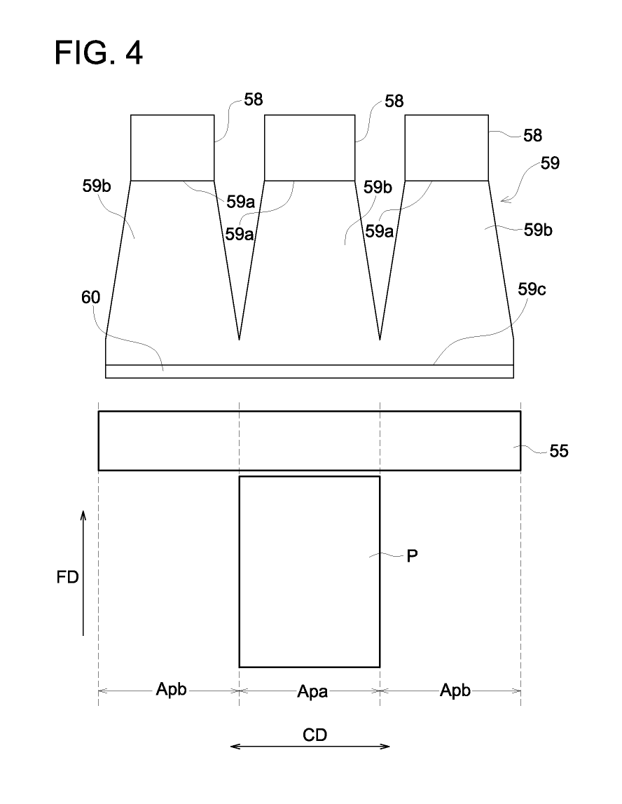

FIG. 4 is a schematic view simply showing the duct 59 and peripheral members thereof. The blow-in opening 59a is constituted so as to correspond to the air blowing opening 58a of the blowing fan 58 in shape. In the present embodiment, 3 bow-in openings 59a are provided corresponding to 3 blowing fans 58. Each blow-in opening 59a is connected to each corresponding blowing fan 58 (air blowing opening 58a) via a heat insulating member 64 (not shown in FIG. 4).

The ventilation guide section 59b is constituted of 3 independent duct sections each having a duct width of the sheet width direction CD gradually increasing toward the blow-out opening 59c from each blow-in opening 59a and a common duct section in which the 3 independent duct sections are assembled together just before the bow-out opening 59c.

The blow-out opening 59c is located at the other end portion of the ventilation guide section 59b, that is, at the end portion of the common duct section and constituted in an elongated rectangular shape (a width-expanded shape) in which the sheet width direction CD corresponds to the longitudinal direction thereof. The width of the sheet width direction CD of this blow-out opening 59c nearly corresponds to the size of the sheet width direction CD of a fixing member (including a fixing belt 54 and a fixing lower roller 55). The blow-out opening 59c, due to its elongated opening shape, can spread separation wind in the sheet width direction CD and prevent wind amount nonuniformity in the sheet width direction CD.

Further, as referred to FIG. 2, the blow-out opening 59c is arranged at a position further shifted to the fixing belt 54 side than the front of the sheet discharge side of the fixing nip portion NP (on the conveyance path FP of the sheet P), and also at a position in which separation wind flows to the fixing belt 54 from the belt tangent direction. Such an arrangement of the blow-out opening 59c is based on an acquired knowledge in which of the fixing belt 54 and the fixing lower roller 55 brought into contact with a sheet P in the fixing nip portion NP, the fixing belt 54 brought into contact with the fixing-intended surface of the sheet P has a strong tendency to be wound by the sheet P.

In this duct 59, the duct wall surface constituting the ventilation guide section 58b, specifically the duct wall surface opposed to the heating roller 52 faces the heating roller 52, and functioning thereby as a heat receiving surface receiving radiation heat from the heating roller 52 (radiation heat resulting from the heater 56). Thereby, in the duct 59, heat exchange is carried out between the duct wall surface and air (separation wind) flowing inside the ventilation guide section 59b, whereby the separation wind can be warmed.

As one of the features of the present embodiment, in the blow-out opening 59c of the duct 59, an opening setting section 60 having an opening region is placed in which the opening width in the sheet width direction CD (hereinafter simply referred to as the “opening width”) is adjustable. By adjusting the opening width as appropriate, this opening setting section 60 can adjust the blowing range in the sheet width direction CD of separation wind blown to the fixing member (hereinafter simply referred to as the “blowing width”).

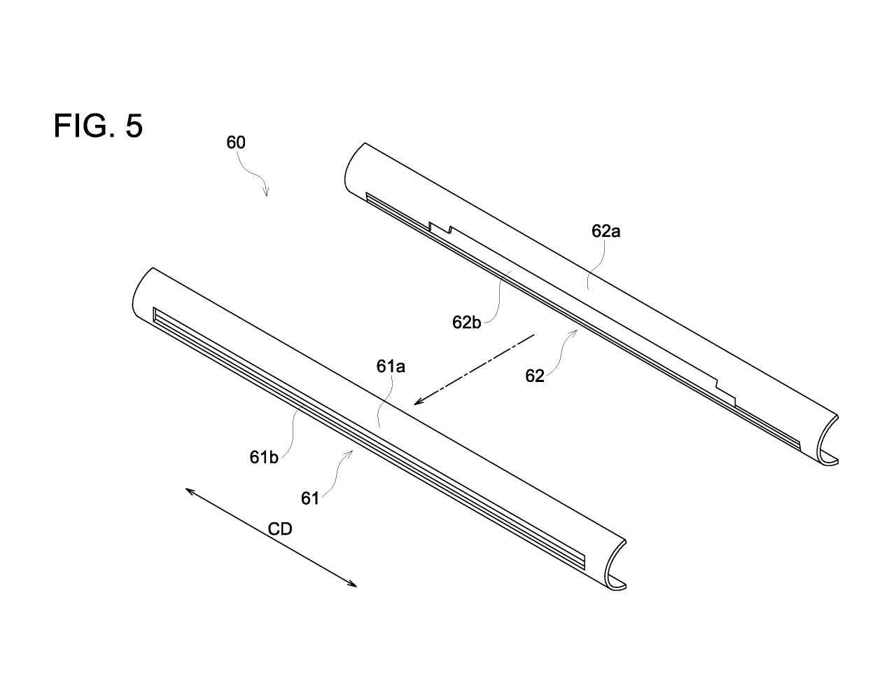

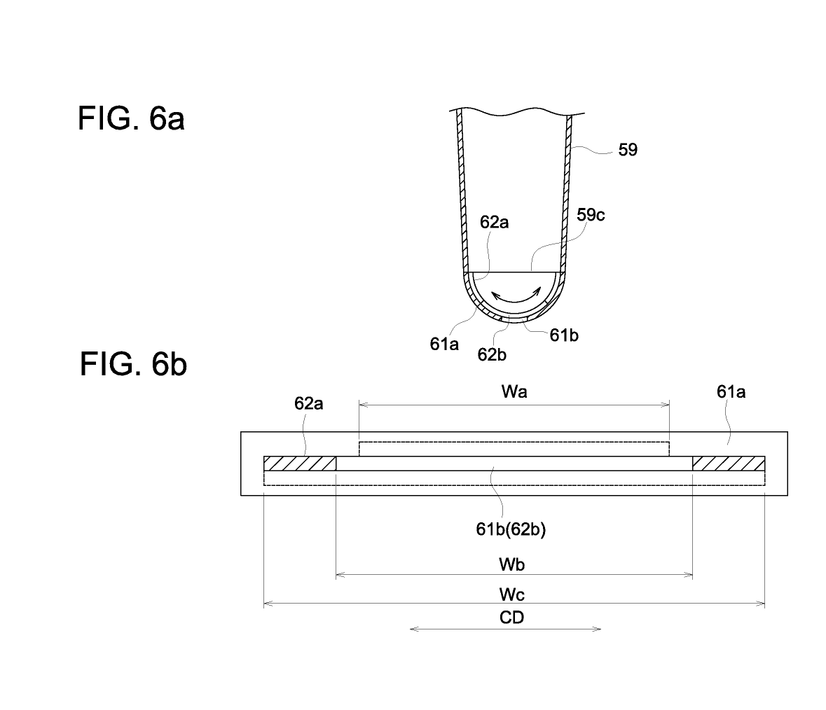

FIG. 5 is an exploded perspective view schematically showing the constitution of the opening setting section 60. Further, each of FIGS. 6-8 is an illustration view showing the operation state of the opening setting section 60. The opening setting section 60 has a fixed plate 61 and a movable plate 62, being constituted by laminating both the movable plate 62 and the fixed plate 61 toward the blow-out direction of separation wind in this sequential order. The opening setting section 60 is attached to the duct 59 covering the entire surface of the blow-out opening 59c so as to be protruded toward the bow-out direction of the separation wind.

The fixed plate 61 is constituted by forming a rectangular opening 61b serving as a first opening in a semicylindrical plate-like member 61a having an arc cross-sectional shape. The extension direction of the plate-like member 61a corresponds to the sheet width direction CD. The rectangular opening 61b is a fixed opening which has an elongated rectangular shape so that the sheet width direction CD is oriented in the longitudinal direction, and the opening width thereof corresponds to the width of the fixing member in the sheet width direction CD.

The movable plate 62 is constituted by forming a convex opening 62b as a second opening in a semicylindrical plate-like member 62a having an arc cross-sectional shape. The extension direction of the plate-like member 62a corresponds to the sheet width direction CD. The convex opening 62b has a multi-step shape in which the opening width changes in the height direction of the opening (a direction corresponding to the sheet conveyance direction FD) in a stepwise manner. In the present embodiment, the convex opening 62b has an opening shape in which the opening width changes in 3 steps of Wa, Wb, and Wc. Specifically, the opening width Wa of the opening portion located on one end portion side of the convex opening 62b corresponds to the sheet width (the sheet width direction CD) of a sheet P having a size smaller than A4 size (the standard sheet size) (for example, B5 size). And, the opening width Wb of the opening portion located in the center of the convex opening 62b corresponds to the sheet width (the sheet width direction CD) of a sheet P having A4 size (the standard sheet size). Further, the opening width We of the opening portion located on the other end portion side of the convex opening 62b corresponds to the sheet width (the sheet width direction CD) of a sheet P having a size larger than A4 size (the standard sheet size) (for example, A3 size). Still further, in the convex opening 62b, the clearance of the height direction of the opening portion corresponding to each of the opening widths Wa, Wb, and We corresponds to the clearance of the height direction of a rectangular opening 61b provided for the fixed plate 61.

As shown by the arrow of FIG. 6a, the movable plate 62 is constituted so as to be slidable on the rear surface of the fixed plate 61 in the height direction (hereinafter referred to as the “slide direction”) of the convex opening 62b. The movable plate 62 is connected to an opening drive section 65 (refer to FIG. 9) incorporating a motor. In response to the drive of this opening drive section 65, the movable plate 62 slides on the fixed plate 61 to set the slide direction position of the movable plate 62.

The opening setting section 60 of such a constitution can set the opening width by an opening region in which the rectangular opening 61b and the convex opening 62b are overlapped. For example, FIG. 6b shows a state in which the opening setting section 60 has set an opening width Wb.

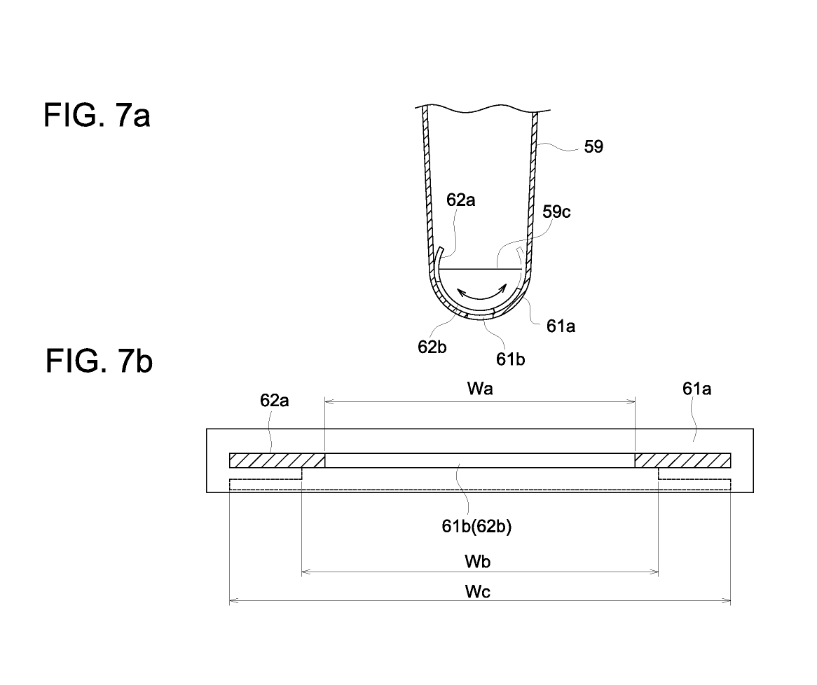

Further, the opening setting section 60 can change the opening width based on the position of the movable plate 62 in the slide direction. As shown in FIGS. 7a and 7b, the movable plate 62 is allowed to move to one slide direction by a predetermined distance, whereby the opening setting section 60 can carry out setting from the opening width Wb to the opening width Wa. Of course, other than the above, for example, for the opening width We, the opening setting section 60 can set various opening widths based on each opening width provided for the convex opening 62b.

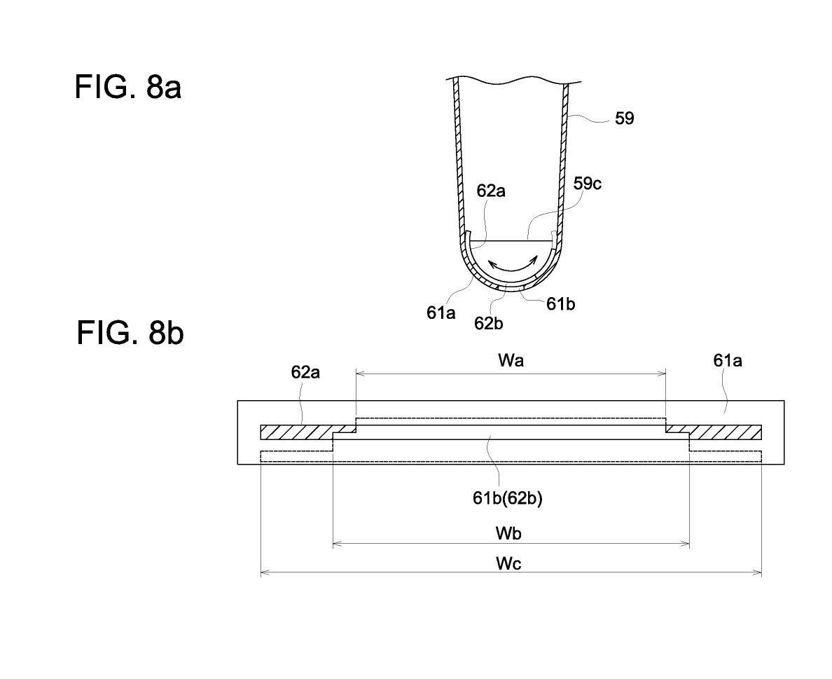

Still further, with respect to the position of the movable plate 62 in the slide direction, a position in which the opening width of the convex opening 62b is switched (hereinafter referred to as the “boarder position”) can also be set in the range of the rectangular opening 61b. Incidentally, FIGS. 8a and 8b show a state in which a boarder position in which the opening width Wa and the opening width Wb are switched has been set in the range of the rectangular opening 61b. Thereby, an intermediate opening between the opening width Wa and the opening width Wb is set in the range of the rectangular opening 61b, whereby for both regions of the opening width Wa in which separation wind is mainly blown out, such separation wind can be blown supplementarily.

Furthermore, with the limit of the height direction range of the rectangular opening 61b, the boarder position is allowed to move to either slide direction, whereby the ratio of the opening width Wb occupied in the rectangular opening 61b is changed. Thereby, the wind amount of the region depending only on the opening width Wb (namely, both side regions of the opening width Wa) can be increased or reduced.

FIG. 9 is a block diagram schematically showing the control system of the image forming apparatus 1 according to the present embodiment. The control system of the image forming apparatus 1 is mainly constituted of an image formation control section 100 and a fixing control section 110. The image formation control section 100 and the fixing control section 110 are constituted so as to be mutually communicable.

As the image formation control section 100, a microcomputer constituted mainly of, for example, a CPU, a ROM, a RAM, and an I/O interface is usable. The image formation control section 100 carries out various operations in response to a control program stored in the ROM. On the basis of the operation results, the operation state of the image forming apparatus 1 is controlled.

This image formation control section 100 can acquire information on printing conditions, for example, single-side•double-side printing types and sheets (for example, the size, the sheet type such as plain paper or thick paper, and the nominal weight), as well as the density and magnification of an image from information set via the operation section (not shown) placed in the main body upper portion of the image forming apparatus 1 or information having been received, together with output image data from a personal computer or another image forming apparatus. Herein, as the operation section, for example, a touch panel enabling to carry out input operations based on information displayed on a display is usable.

The image formation control section 100 controls each section (the image forming unit) of the image forming apparatus 1 to carry out a series of the following processes, whereby a toner image is transferred onto a sheet P conveyed.

(1) The photoreceptors 31Y-31K are charged.

(2) Electrostatic latent images are formed on the photoreceptors 31Y-31K by the exposure sections 20Y-20K.

(3) Toners are allowed to adhere to the thus-formed electrostatic latent images.

(4) The toner images on the photoreceptors 31Y-31K are primarily transferred onto the intermediate transfer belt 41.

(5) A sheet P is conveyed.

(6) The toner image on the intermediate transfer belt 41 is secondarily transferred onto the sheet P.

As the fixing control section 110, a microcomputer constituted mainly of, for example, a CPU, a ROM, a RAM, and an I/O interface is usable. The fixing control section 110 carries out various operations in response to a control program stored in the ROM. On the basis of the operation results, the operation state of the fixing device 50 is controlled. Incidentally, in this fixing control section 110, sensor signals from various sensors including a roller temperature detection sensor 115 and signals from the image formation control section 100 have been input in advance. Herein, the roller temperature detection sensor 115 is a sensor to detect the temperature of the fixing belt 54 in the vicinity of the fixing nip portion NP. For example, a thermistor is usable. This roller temperature detection sensor 115 is arranged, for example, plurally with an appropriate distance so as to detect the temperature distribution of the entire region of the fixing belt 54 in the sheet width direction CD.

The fixing control section 110, if functionally considered, has a main control section 111 and a blowing control section 112.

The main control section 111 controls each section of the fixing device 50 to control fixing of a toner image onto the fixing-intended surface of a sheet P. Specifically, the main control section 111 controls the heater 60 to manage the fixing temperature and the heating region (the center heating region and the outside heating region). Further, in response to signals from the image formation control section 100, the main control section 111 controls the rotation timing and rotation velocity of the heating roller 52 and the fixing lower roller 55 each. Still further, in response to signals from the image formation control section 100, the main control section 111 outputs a control signal to the blowing control section 3b.

The blowing control section 112 functions to control the blowing region of separation wind, incorporating a fan control section 113 and an opening control section 114. The fan control section 113 controls the operation initiation and operation termination of the blowing fan 58 and also controls the wind amount of the blowing fan 58. Herein, in the present embodiment, the fan control section 113 controls the blowing fan 58 so that the wind amount of the blowing fan 58 remains constant during blowing of separation wind. On the other hand, the opening control section 114 controls the opening drive section 65 to control the opening width of the opening setting section 60 to control the blowing width of separation wind blown out from the blowing opening 59c of the duct 59 to the fixing member.

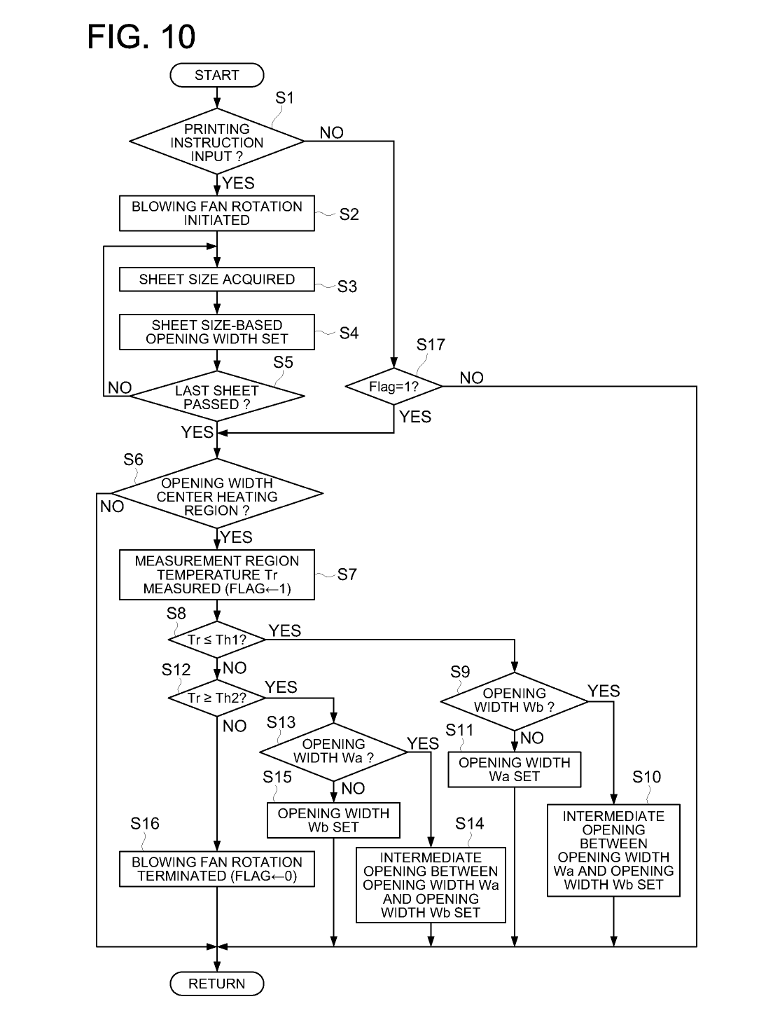

FIG. 10 is a flowchart showing the control procedure of the fixing device 50 by focusing on the control of the blowing width of separation wind according to the present embodiment. The processing shown in this flowchart is carried out by the fixing control section 110 via the power activation of the image forming apparatus 1 as the trigger.

Initially, in Step 1 (S1), the main control section 111 judges whether a printing instruction has been input for a job with respect to printing (image formation) on at least one sheet P via a control signal from the image formation control section 100. Herein, when the user carries out printing using the image forming apparatus 1, a printing instruction has already been input in the image formation control section 100 together with printing conditions via the operation of the operation section 4 or together with printing conditions•output image data from a personal computer or another image forming apparatus. When an image formation operation is initiated, the image formation control section 100 has already output the printing instruction to the main control section 11 together with the printing conditions.

In Step 1, when an affirmative judgment has been made, namely, when a print instruction has been input, a progress to Step 2 (S2) is made. On the other hand, in Step 1, when a negative judgment has been made, namely, when no printing instruction has been input, a progress to Step 17 (S17) (to be described later) is made.

In Step 2, the fan control section 113 controls the blowing fan 58 to initiate the operation of the blowing fan 58. In this case, the fan control section 113 controls the blowing fan 58 at a constant wind velocity so that the wind amount of separation wind blown from the blowing fan 58 becomes a preset specific wind velocity.

In Step 3 (S3), the opening control section 114 acquires the size (the sheet size) of a fixing-intended sheet P based on printing conditions.

In Step 4 (S4), prior to fixing for a fixing-intended sheet P, the opening control section 114 controls the opening drive section 65 to set the opening setting section 60 at an opening width corresponding to the size of the fixing-intended sheet P. Herein, the fixing-intended sheet P is considered to have B5 size. In this case, the opening control section 114 sets the opening setting section 65 at an opening width Wa. On the other hand, the main control section 11 energizes only the center lamp 56a among the lamps 56a and 56b constituting the heater 56 to heat the center heating region based on the fixing temperature.

In Step 5 (S5), the main control section 111 judges that a sheet P has been passed through the fixing section 51 associated with fixing, and immediately judges whether the sheet P having been passed through the fixing section 51 is the last sheet, namely, whether the sheet P corresponds to the last sheet P among at least one sheet P subjected to fixing as a job. In Step 5 (S5), when an affirmative judgment has been made, namely, when the sheet P having been passed through the fixing section 51 is the last sheet, a progress to Step 6 (S6) is made. On the other hand, in Step 5, when a negative judgment has been made, namely, when the sheet P having been passed through the fixing section 51 is not the last sheet, a return to Step 3 is made, and then the above-described processing is carried out for the next fixing-intended sheet P.

In Step 6, the opening control section 114 receives information that the main control section 111 has judged the termination of fixing for a sheet P associated with a job in Step 5, and then judges whether the opening width of the opening setting section 60 is smaller than the width of the center heating region. In Step 6, when an affirmative judgment has been made, namely, when the opening width of the opening setting section 60 is smaller than the width of the center heating region, a progress to Step 7 (S7) is made. On the other hand, in Step 6, when a negative judgment has been made, namely, when the opening width of the opening setting section 60 is equal to or larger than the width of the center heating region, an exit from the present routine is made.

In Step 7, the opening control section 114 reads in a detection result of the roller temperature detection sensor 115 to measure the temperature Tr of a measurement region. This measurement region corresponds to a heating region by the heater 56 and a region overlapped with the non-sheet passing region Apb of a sheet P, that is, regions having a predetermined width each located on both sides of the sheet passing region Apa of the sheet P. In the present embodiment, the center heating region and the region overlapped with the non-sheet passing region Apb of a sheet P of B5 size correspond to the measurement region.

Further, in Step 7, the opening control section 114 sets the control flag to “1” showing that the fixing temperature is being controlled by the opening setting section 60.

In Step 8 (S8), the opening control section 114 judges whether the temperature Tr is at most a low temperature judgment value Tth1. This low temperature judgment value Tth1 is a value corresponding to the upper limit temperature in a low temperature state unallowable for the fixing temperature. From the viewpoint of fixing performance, the optimum value is set via experiments and simulations. In Step 8, when an affirmative judgment has been made, namely, when the temperature Tr is at most the low temperature judgment value Tth1, a progress to Step 9 (S9) is made. On the other hand, in Step 8, when a negative judgment has been made, namely, when the temperature Tr is higher than the low temperature judgment value Tth1, a progress to Step 12 (S12) is made.

In Step 9, the opening control section 114 judges whether the opening setting section 60 has been set at the opening width Wb. In Step 9, when an affirmative judgment has been made, namely, when the opening setting section 60 has been set at the opening width Wb, a progress to Step 1 (S1) is made. On the other hand, in Step 9, when a negative judgment has been made, namely, when the opening setting section 60 has been set at any width other than the opening width Wb, a progress to Step 11 (S11) is made. Herein, in the judgment of Step 9, when the opening width Wb has not been set independently as set to an intermediate opening between the opening width Wa and the opening width Wb, a negative judgment is made.

In Step 10, the opening control section 114 sets the opening setting section 60 to an intermediate opening between the opening width Wa and the opening width Wb. For example, this intermediate opening is set so that with respect to the clearance of the opening in the height direction, the ratio of the opening width Wa to the opening width Wb becomes 1:1. Namely, as the process led to Step 10, it is thought that as the previous state, the opening setting section 60 has been set at the opening width Wb, whereby in the center heating region of the fixing member, the temperature is decreasing on both sides (the non-sheet passing region Apb) of the sheet passing region Apa of a sheet P of B5 size. Therefor, the opening setting section 60 is set to an intermediate opening between the opening width Wa and the opening width Wb to decrease the wind amount of separation wind being been blown to the non-sheet passing region Apb of the fixing member.

On the other hand, in Step 11, the opening control section 114 sets the opening setting section 60 at the opening width Wa. Namely, as the process led to Step 11, it is thought that as the previous state, although the opening setting section 60 has been set to an intermediate opening between the opening width Wa and the opening width Wb, in the center heating region of the fixing member, a low temperature state is continuing on both sides (the non-sheet passing region Apb) of the sheet passing region Apa of a sheet P of B5 size. Therefor, the opening setting section 60 is set at the opening width Wa to terminate separation wind being been blown to the non-sheet passing region Apb of the fixing member.

In contrast, in Step 12 (S12), the opening control section 114 judges whether the temperature Tr is at least a high temperature judgment value Tth2. This high temperature judgment value Tth2 is a value corresponding to the lower limit temperature in a high temperature state unallowable for the fixing temperature. From the viewpoint of fixing performance, the optimum value is set via experiments and simulations. In Step 12, when an affirmative judgment has been made, namely, when the temperature Tr is at least the high temperature judgment value Tth2, a progress to Step 13 (S13) is made. On the other hand, in Step 12, when a negative judgment has been made, namely, when the temperature Tr is lower than the high temperature judgment value Tth2, a progress to Step 16 (S16) is made.

In Step 13, the opening control section 114 judges whether the opening setting section 60 has been set at the opening width Wa. In Step 13, when an affirmative judgment has been made, namely, when the opening setting section 60 has been set at the opening width Wa, a progress to Step 14 (S14) is made. On the other hand, in Step 13, when a negative judgment has been made, namely, when the opening setting section 60 has been set at any width other than the opening width Wa, a progress to Step 15 (S15) is made. Herein, in the judgment of Step 13, when the opening width Wa has not been set independently as set to an intermediate opening between the opening width Wa and the opening width Wb, a negative judgment is made.

In Step 14, the opening control section 114 sets the opening setting section 60 to an intermediate opening between the opening width Wa and the opening width Wb. Namely, as the process led to Step 14, it is thought that as the previous state, the opening setting section 60 has been set at the opening width Wa, whereby in the center heating region of the fixing member, the temperature is increasing on both sides (the non-sheet passing region Apb) of the sheet passing region Apa of a sheet P of B5 size. Therefor, the opening setting section 60 is set to an intermediate opening between the opening width Wa and the opening width Wb to blow separation wind to the non-sheet passing region Apb of the fixing member.

On the other hand, in Step 15, the opening control section 114 sets the opening setting section 60 at the opening width Wb. Namely, as the process led to Step 15, it is thought that as the previous state, although the opening setting section 60 has been set to an intermediate opening between the opening width Wa and the opening width Wb, in the center heating region of the fixing member, a high temperature state is continuing on both sides (the non-sheet passing region Apb) of the sheet passing region Apa of a sheet P of B5 size. Therefor, the opening setting section 60 is set at the opening width Wb to increase the wind amount of separation wind blown to the non-sheet passing region Apb of the fixing member.

In contrast, in both Steps 8 and 12, negative judgments have been made, in Step 16, the fan control section 113 controls the blowing fan 58 to terminate the operation of the blowing fan 58. Further, the opening control section 114 sets the control flag to “0” in response to the operation termination of the blowing fan 58.

Further, in Step 17 (S17) preceded by a negative judgment of Step 1, the opening control section 114 judges whether the control flag is “1.” In Step 17, an affirmative judgment has been made, namely, when the control flag is “1,” a progress to Step 6 described above is made. On the other hand, in Step 17, a negative judgment has been made, namely, when the control flag is “0,” an exit from the present routine is made.

In this manner, in the present embodiment, the image forming apparatus 1 is provided with an opening setting section 60 to set the blowing width of separation wind blown to the fixing member from the blowing fan 58 via an opening whose opening width is adjustable. And, the fixing control section 110 controls the opening width of the opening setting section 60 based on the temperature of the fixing member.

Such a constitution makes it possible that the opening setting section 60 controls the blowing width of separation wind. Thereby, the decrease or increase of the temperature of the fixing member in the non-sheet passing region Apb resulting from separation wind to separate a sheet from the fixing member can be effectively inhibited. Namely, the blowing width of such separation wind can be expanded or reduced, whereby the wind amount of the separation wind in the non-sheet passing region Apb of the fixing member can be freely controlled. Therefore, even when a sheet size is smaller than the blowing width of separation wind, the wind amount of the separation wind in the non-sheet passing region Apb of the sheet P can be decreased, whereby the decrease of the temperature of the fixing member in the above region Apb can be inhibited. Thereby, the disadvantage that the electrical power of the heater 56 to heat the fixing member is increased beyond necessity can be overcome. Further, even when the heating region of the fixing member is larger than the sheet passing region Apa, the wind amount of separation wind in the non-sheet passing region Apb of the sheet P can be increased, whereby the increase of the temperature of the fixing member in the non-sheet passing region Apb can be inhibited. Thereby, degradation of the fixing member can be effectively inhibited.

Further, in the present embodiment, the blowing section 57 has a blowing fan 58 and a duct 59. The duct 59 is provided with a blowing opening 59c arranged by approaching the sheet discharge side of a sheet P in the fixing nip portion NP and constituted in a width-expanded shape in the sheet width direction CD to introduce separation wind having been blown from the blowing fan 58 to the blow-out opening 59c. In this case, the opening setting section 60 is placed in the blow-out opening 59c of the duct 59.

Separation wind blown out from the blowing fan 58 tends to flow in a spreading manner when having been blown out from the air blowing opening 58a. Therefor, the opening setting section 60 is placed in the bow-out opening 59c approaching the sheet discharge side of the sheet P in the nip portion NP, whereby the bowing width of separation wind blown to the fixing member can be appropriately controlled. Thereby, the decrease or increase of the temperature of the fixing member in the non-sheet passing region Apb can be effectively inhibited.

Further, in the present embodiment, prior to fixing for a sheet P, the fixing control section 110 controls the opening width of the opening setting section 60 based on the size of the sheet width direction CD of a fixing-intended sheet P. Thereby, the blowing width of separation wind based on the size of the sheet P can be realized, whereby without impairing the air separation function, the decrease of the temperature of the fixing member in the non-sheet passing region Apb of the sheet P can be inhibited.

Further, in the present embodiment, after termination of fixing for a sheet P, the fixing control section 110 controls the opening width of the opening setting section 60 based on the temperature Tr of the non-sheet passing region Apb of the fixing member. Thereby, even when the temperature of the non-sheet passing region Apb of the fixing member is increased or decreased due to passing of a sheet P associated with fixing and separation wind, the wind amount of the separation wind in the non-sheet passing region Apb is controlled, whereby the decrease or increase of the temperature of the non-sheet passing region Apb of the sheet P can be effectively inhibited.

Further, in the present embodiment, when the temperature Tr of the non-sheet passing region Apb of the fixing member is at least the high temperature judgment value Tth2, the fixing control section 110 controls the opening width of the opening setting section 60 so that separation wind is blown out to the non-sheet passing region Apb of the fixing member. Thereby, the separation wind is blown to the non-sheet passing region Apb of the fixing member in a high temperature state, whereby the temperature of the region Apb can be decreased.

When the temperature Tr of the non-sheet passing region Apb of the fixing member continues to be at least the high temperature judgment value Tth2, the fixing control section 114 controls the opening width of the opening setting section 60 so that the wind amount of separation wind in the non-sheet passing region of the fixing member increases. Thereby, the wind amount of the separation wind blown to the non-sheet passing region Apb of the fixing member in a high temperature state is increased, whereby the temperature of the region Apb can be decreased.

Further, in the present embodiment, when the temperature T of the non-sheet passing region Apb of the fixing member is at least the low temperature judgment value Tth1, the fixing control section 114 controls the opening width of the opening setting section 60 so that the wind amount of separation wind in the non-sheet passing region Apb of the fixing member decreases. Thereby, the wind amount of the separation wind blown to the non-sheet passing region Apb of the fixing member in a low temperature state is decreased, whereby the decrease of the temperature of the region Apb can be inhibited.

When the temperature Tr of the non-sheet passing region Apb of the fixing member continues to be at least the low temperature judgment value Tth1, the fixing control section 114 controls the opening width of the opening setting section 60 so that separation wind being been blown to the non-sheet passing region Apb of the fixing member terminates. Thereby, the separation wind blown to the non-sheet passing region Apb of the fixing member in a low temperature state created via separation wind blowing is terminated, whereby the decrease of the temperature of the region Apb can be inhibited.

Further, in the present embodiment, the opening setting section 60 is provided with a fixed plate 61 having a rectangular opening 61a which is a single opening whose opening width corresponds to the fixing member, as well as a movable plate 62 having a convex opening 62b which is laminated with this fixed plate 61 and provided with a multi-step shape in which the opening width is changed in the height direction of the opening in a stepwise manner. Herein, the opening setting section 60 slides the movable plate 62 with respect to the fixed plate 61 to set the opening width based on an opening region in which the rectangular opening 61b and the convex opening 62b are overlapped. Such a constitution makes it possible to easily set any appropriate opening width based on the opening region where the rectangular opening 61b and the convex opening 62b are overlapped. Thereby, the blowing width of separation wind can be freely controlled.

Incidentally, in the operation description using the flowchart shown in FIG. 10, with a prior condition in which the sheet P has B5 size, the temperature change of the non-sheet passing region Apb generated by use of the center heating region corresponding to A4 size has been described as an example. However, the present embodiment is not limited to such an embodiment. It goes without saying that various modifications can be made as in a case that with a prior condition in which the sheet P has A4 size, the temperature change of the non-sheet passing region Apb generated by use of a heating region corresponding to A3 size is inhibited.

Further, in the above embodiment, in the description of Steps 10 and 14, the intermediate opening is set so that the ratio of the opening width Wa to the opening width Wb is 1:1. However, with regard to the intermediate opening, based on the temperature Tr, the ratio of the opening width Wa to the opening width Wb may be adjusted to realize an appropriate wind amount for the non-sheet passing region Apb.

Still further, in the embodiment, the convex opening 62b of the movable plate 62 is provided with 3 opening widths Wa-Wc but with no limitation thereto, such an opening may be set in a multi-step manner with more steps.

### Second Embodiment

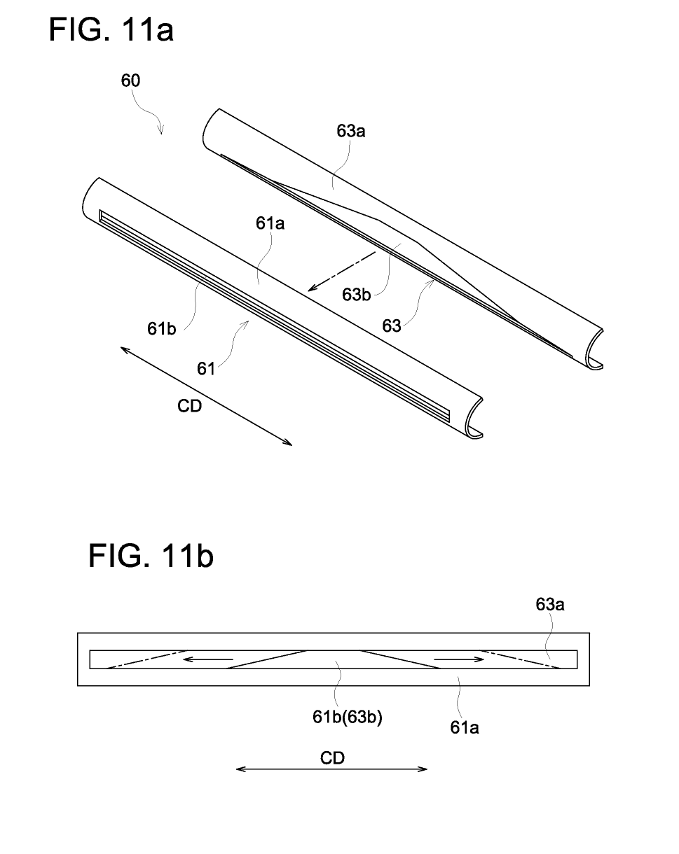

FIGS. 11a and 11b show a schematic illustration view of the constitution of the opening setting section 60 according to a second embodiment. The difference of the opening setting section 60 according to the second embodiment from that of the first embodiment is that the movable plate 62 is replaced with a movable plate 63. The following description will be made by focusing on different points in which with respect to parts overlapped with those in the first embodiment, only symbols will be cited and the description will be omitted.

The movable plate 63 is constituted by forming a trapezoidal opening 63b serving as a second opening in a semicylindrical plate-like member 62a having an arc cross-sectional shape. The extension direction of the plate-like member 63a corresponds to the sheet width direction CD. The trapezoidal opening 63b is shaped in which the opening width thereof linearly varies in the height direction of the opening. In the present embodiment, with regard to the trapezoidal opening 63b, the narrowest portion of the opening width corresponds to the sheet width (the sheet width direction CD) of a sheet P having a size smaller than A4 size (the standard size) (for example, B5 size), and the widest portion of the opening corresponds to the sheet width of a sheet P having a size larger than A4 size (the standard sheet size) (for example, A3 size).

The opening setting section 60 having such a constitution can set the opening width by an opening region in which the rectangular opening 61b and the trapezoidal opening 63b are overlapped.

Such a constitution makes it possible to easily set any appropriate opening width based on the opening region where the rectangular opening 61b and the trapezoidal opening 63b are overlapped. Thereby, the blowing width of separation wind can be freely controlled. Further, the opening width can be linearly adjusted. Therefore, on an occasion of use in which a variety of unspecified sheet sizes are frequently used, the opening width can be effectively set. However, in the case of use of the movable plate 62 shown in the first embodiment, the opening width can be effectively set on an occasion of use in which the range of used sheets P is specified as in sizes of B5, A4, and A3.

Hereinbefore, the image forming apparatus according to the embodiments of the present invention has been described. However, the present invention is not limited to the above embodiments. It goes without saying that various modifications can be made within the scope of the present invention. The fixing device itself constituting the image forming apparatus also functions as a part of the present invention.

According to the above embodiments, the control section to control the fixing device is separately provided, but such a function may also be realized by the control section of the image forming apparatus. In the embodiments, 3 blowing fans are provided, but only a single fan is also employable to realize this function.

The embodiments of the present invention make it possible to control the blowing width of separation wind by an opening setting section based on the temperature of the fixing member. Thereby, the blowing width of the separation wind can be expanded or reduced, whereby the wind amount of the separation wind in the non-sheet passing region of the fixing member can be freely controlled. Thereby, using separation wind, a sheet can be separated from the fixing member and at the same time the decrease or increase of the temperature of the fixing member in the non-sheet passing region resulting from this separation wind can be effectively inhibited.

What is claimed is:

1. A fixing device comprising:
a fixing section which passes a sheet through a fixing nip portion formed by press-contacting a pair of fixing members with each other and thereby fixes a toner image on the sheet by heating, the toner image having been transferred onto the sheet;
a blowing section which blows separation wind from a sheet discharge side of the fixing nip portion to the fixing members to separate the sheet from the fixing members;
an opening setting section which is provided with an opening region in which an opening width in a sheet width direction is adjustable, and adjusts a blowing range in the sheet width direction of the separation wind blown through the opening range from the blowing section to the fixing members;
a temperature detection sensor for detecting temperature of the fixing members; and
a control section which controls the opening width of the opening setting section based on the temperature detected of the fixing members.

2. The fixing device of claim 1, wherein the blowing section includes:
a blowing device for generating separation wind; and
a duct arranged along the sheet discharge side of the fixing nip portion and constituted in a width-expanded shape in the sheet width direction to introduce the separation wind blown from the blowing device to a blow-out opening, and
wherein the opening setting section is placed at the blow-out opening of the duct.

3. The fixing device of claim 1, wherein, prior to fixing the toner image on the sheet, the control section controls the opening width of the opening setting section corresponding to a size of the sheet width direction of the sheet to be fixed.

4. The fixing device of claim 3, wherein, after a termination of fixing the toner image on the sheet, the control section controls the opening width of the opening setting section based on a temperature of a non-sheet passing region of the fixing members.

5. The fixing device of claim 4, wherein, when the temperature of the non-sheet passing region of the fixing members is equal to or higher than a high temperature judgment value for judging a high temperature state of the fixing members, the control section controls the opening width of the opening setting section to blow out separation wind to the non-sheet passing region of the fixing members.

6. The fixing device of claim 5, wherein, when the temperature of the non-sheet passing region of the fixing members continues to be equal to or higher than the high temperature judgment value, the control section controls the opening width of the opening setting section to increase wind amount of separation wind in the non-sheet passing region of the fixing members.

7. The fixing device of claim 4, wherein, when the temperature of the non-sheet passing region of the fixing members is equal to or lower than a low temperature judgment value, the control section controls the opening width of the opening setting section to decrease wind amount of separation wind in the non-sheet passing region of the fixing members.

8. The fixing device of claim 7, wherein, when the temperature of the non-sheet passing region of the fixing members continues to be equal to or lower than the low temperature judgment value, the control section controls the opening width of the opening setting section to stop the separation wind blown to the non-sheet passing region of the fixing members.

9. The fixing device of claim 1, wherein, the opening setting section is provided with a first plate having a first opening whose opening width corresponds to the fixing members in the sheet width direction, and a second plate which is overlapped with the first plate and provided with a second opening which is an opening of a multi-step shape whose opening width varies in a height direction of the opening in a stepwise manner, wherein the second plate slides with respect to the first plate to set the opening width by the opening region in which the first opening and the second opening are overlapped.

10. The fixing device of claim 1, wherein, the opening setting section is provided with a first plate having a first opening which is a single opening whose opening width corresponds to the fixing members in the sheet width direction, and a second plate which is overlapped with the first plate and provided with a second opening which is a trapezoidal shaped opening in which an opening width thereof linearly varies in a height direction of an opening region, wherein the second plate slides with respect to the first plat to set the opening width by the opening region in which the first opening and the second opening are overlapped.

11. An image forming apparatus comprising:
an image forming unit which transfers toner image onto a sheet; and
a fixing unit which performs a fixing processing to the sheet onto which the toner image is transferred, the fixing unit including,
a fixing section which passes the sheet through a fixing nip portion formed by press contacting a pair of fixing members with each other and thereby fixes a toner image on the sheet by heating, the toner image having been transferred onto the sheet;
a blowing section which blows separation wind from a sheet discharge side of the fixing nip portion to the fixing members to separate the sheet from the fixing members;
an opening setting section which is provided with an opening region in which an opening width in a sheet width direction is adjustable, and adjusts a blowing range in the sheet width direction of the separation wind blown through the opening range from the blowing section to the fixing members;
a temperature detection sensor for detecting temperature of the fixing members; and
a control section which controls the opening width of the opening setting section based on the temperature detected of the fixing members.

12. The image forming apparatus of claim 11, wherein the blowing section includes:
a blowing device for generating separation wind; and
a duct arranged along the sheet discharge side of the fixing nip portion and constituted in a width-expanded shape in the sheet width direction to introduce the separation wind blown from the blowing device to a blow-out opening, and
wherein the opening setting section is placed at the blow-out opening of the duct.

13. The image forming apparatus of claim 11, wherein, prior to fixing the toner image on the sheet, the control section controls the opening width of the opening setting section corresponding to a size of the sheet width direction of the sheet to be fixed.

14. The image forming apparatus of claim 13, wherein, after a termination of fixing the toner image on the sheet, the control section controls the opening width of the opening setting section based on a temperature of a non-sheet passing region of the fixing members.

15. The image forming apparatus of claim 14, wherein, when the temperature of the non-sheet passing region of the fixing members is equal to or higher than a high temperature judgment value for judging a high temperature state of the fixing members, the control section controls the opening width of the opening setting section to blow out separation wind to the non-sheet passing region of the fixing members.

16. The image forming apparatus of claim 15, wherein, when the temperature of the non-sheet passing region of the fixing members continues to be equal to or higher than the high temperature judgment value, the control section controls the opening width of the opening setting section to increase the wind amount of separation wind in the non-sheet passing region of the fixing members.

17. The image forming apparatus of claim 14, wherein, when the temperature of the non-sheet passing region of the fixing members is equal to or lower than a low temperature judgment value, the control section controls the opening width of the opening setting section to decrease the wind amount of separation wind in the non-sheet passing region of the fixing members.

18. The image forming apparatus of claim 17, wherein, when the temperature of the non-sheet passing region of the fixing members continues to be equal to or lower than the low temperature judgment value, the control section controls the opening width of the opening setting section to stop the separation wind blown to the non-sheet passing region of the fixing members.

19. The image forming apparatus of claim 11, wherein, the opening setting section is provided with a first plate having a first opening whose opening width corresponds to the fixing members in the sheet width direction, and a second plate which is overlapped with the first plate and provided with a second opening which is an opening of a multi-step shape whose opening width varies in a height direction of the opening in a stepwise manner, wherein the second plate slides with respect to the first plate to set the opening width by the opening region in which the first opening and the second opening are overlapped.

20. The image forming apparatus of claim 11, wherein, the opening setting section is provided with a first plate having a first opening which is a single opening whose opening width corresponds to the fixing members in the sheet width direction, and a second plate which is overlapped with the first plate and provided with a second opening which is a trapezoidal shaped opening in which an opening width thereof linearly varies in a height direction of an opening region, wherein the second plate slides with respect to the first plate to set the opening width by the opening region in which the first opening and the second opening are overlapped.
